(19) United States
(12) Patent Application Publication
(10) Pub. No.: US 2021/0215948 A1
(43) Pub. Date: Jul. 15, 2021

(54) 3D Target Shooting Training Glasses and Target

(71) Applicant: Douglas BUCKLEY, Corona, CA (US)

(72) Inventor: Douglas BUCKLEY, Corona, CA (US)

(21) Appl. No.: 16/742,900

(22) Filed: Jan. 14, 2020

(51) Int. Cl. G02B 30/22; F41G 3/26; F41J 1/01

(52) U.S. Cl. CPC G02B 30/22; F41J 1/01; F41G 3/26

(57) ABSTRACT

Improvements in a 3D target shooting training glasses and target. The 3D target, shooting glasses and training system that allows starting shooters and experienced shooters to improve their skills and accuracy. The paper targets are printed with offset colors that create a 3D image when viewed through 3D glasses. The offset is typically filtered for a red color and a blue color to provide a depth to the image. Shooting glasses are used with each lens providing a color filter to allow a 3D printed target depth perception and sighting training through a dominant eye. The 3D target shooting training glasses and target to provide a training system that allows a user to identify a dominant eye and use the glasses and 3D printed image to aim using the dominant eye on the target while maintaining peripheral vision.

### CROSS REFERENCE TO RELATED APPLICATION

This application claims the benefit of Provisional Application Ser. No. 62/792,014 filed Jan. 14, 2019 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in shooting targets and training for target shooting. More particularly, the present 3D target shooting training glasses and target creates a target, shooting glasses and training system that allows starting shooters and experienced shooters to improve their skills and accuracy.

### Description of Related Art Including Information Disclosed Under 37 CFR 1.97 and 1.98

Shooting targets are typically black and white circular images or a silhouette image that can also often include some red colored areas. Other targets can have the appearance of person or animal and are formed in a three-dimensional figure. These simple targets do not provide a training to teach a user to sight the target through a dominant eye to improve shooting skills and accuracy.

A number of patents and or publications have been made to address these issues. Exemplary examples of patents and or publication that try to address this/these problem(s) are identified and discussed below.

U.S. Pat. No. 8,982,181 issued on Mar. 17, 2015 to Billy Newbery and is titled Digital Stereo Photographic System. This patent provides a complete system for three-dimensional (3D) (stereo) still photography in a digital format. This includes capturing the image or photo, viewing, printing and projecting it. Intermediate steps would include downloading images to a computer, editing, enhancing or modifying, saving, recording photo images to other storage medium, and the printing of still photos. This patent does not provide a shooting target or a training system for target shooters.

U.S. Pat. No. 1,145,585 issued on Jul. 6, 1915 to A. F. Hebard and is titled Target. This patent discloses a paper target with a printed image. The printed image is shown as concentric circles and/or with images of animals. The images are not printed from a stereo image and are viewing the images with 3D glasses does not produce an image with an apparent realistic depth.

What is needed is a 3D target, shooting glasses and training system that allows starting shooters and experienced shooters to improve their skills and accuracy. The 3D printed target, and glasses disclosed in this document provides the solution.

### BRIEF SUMMARY OF THE INVENTION

It is an object of the 3D target shooting training glasses and target to use paper targets as a base material for the targets. Paper targets provide a cost-effective material that can be quickly installed, removed and saved to keep a record of the shooting event replaced to restart when the target has an excessive number of impacts.

It is an object of the 3D target shooting training glasses and target for the target to be printed with offset colors that create a 3D image when viewed through 3D glasses. The offset is typically filtered for a red color and a blue color to provide a depth to the image. The target images are selected to provide an image that gives the appearance of a focal point or points for a shooter to aim or focus.

It is another object of the 3D target shooting training glasses and target to include shooting glasses for eye protection and safety. Proper eye protection prevents material from being ricocheted back towards a person and into an eye. The eye protection can be for indoor or outdoor use. Each lens can be a different color to allow a 3D printed target depth perception and sighting training through a dominant eye.

It is another object of the 3D target shooting training glasses and target to provide a training system that allows a user to identify a dominant eye and use the glasses and 3D printed image to aim using the dominant eye on the target. Initially identification and selection of dominant eye can seem awkward to a user, with practice the training using the 3D glasses and 3D target allows a user to accurately shoot at any type of target with clear shooting glasses.

It is still another object of the 3D target shooting training glasses and target to allow a user to use the non-dominant eye for peripheral vision while using the dominant eye to focus on the target. Maintaining peripheral vision allows the shooter to view additional threats and changes in the surrounding environment.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an 3D target shooting training glasses and target.

FIG. 2A-2C show the filtered and unfiltered target image.

FIGS. 3L and 3R show the apparent image of the target through each lens.

FIG. 4A show the image from the target for a person with a right dominant eye.

FIG. 4B show the image from the target for a person with a left dominant eye.

FIG. 5 shows a flow chart of acquiring a target image and training a shooter.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Item Numbers and Description

| | |
|---|---|
| 19 shooter | 20 firearm |
| 21 sights | 30 filtered glasses |
| 31 film | 50 target |
| 50B target blue image | 50R target red image |
| 51 closest apparent point | 51B blue closest apparent point |
| 51R red closest apparent point | 52 farthest apparent point |
| 52B blue farthest apparent point | 52R red farthest apparent point |
| 53B view of attacker gun barrel | 53R view of attacker gun barrel |
| 54B shooter view of gun sites | 54R shooter view of gun sites |
| 60 filtered shooting glasses | 61B blue filtered lens |
| 61R red filtered lens | 68L left ear frame |
| 68R right ear frame | 69 nose bridge |
| 70 capture stereo image with filters | 71 print target |
| 72 locate target | 73 don 3D glasses |
| 74 determine dominant eye | 75 practice |

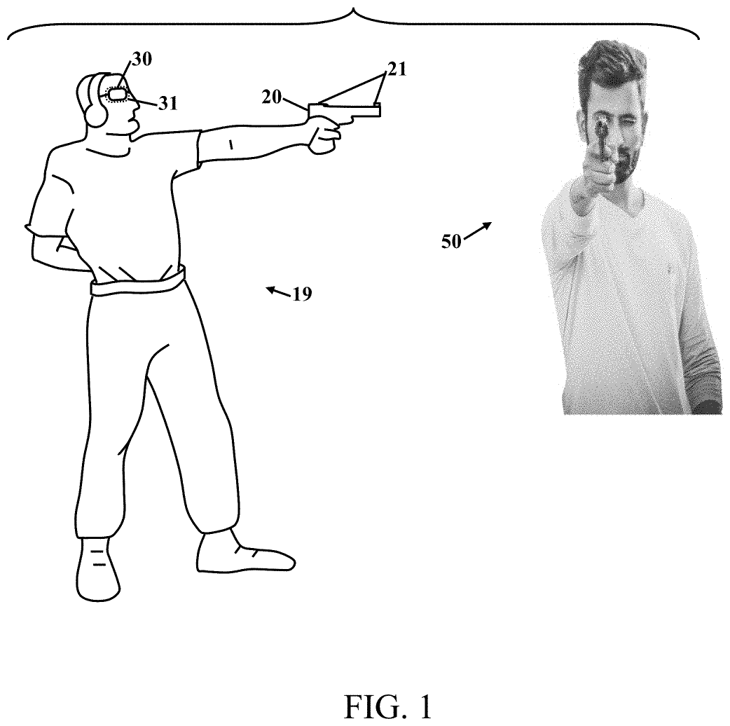

FIG. 1 shows an 3D target shooting training glasses and target. Many starting firearm shooters 19 begin shooting at a target 50 with little or no training. They begin by pointing the firearm 20 at a target 50 and over time they begin to find a correlation of how the sights 21 of the firearm 20 indicate where a projectile will impact the target. They may find that they have a dominant eye to site through the sights 21. Depending upon the distance of the shooter 19 to the target 50 and the desired or perceived accuracy the shooter 19 may never realize the shift in impact on a target when sighting through either particular eye. The use of a 3-D target 50 with filtered glasses 30 makes the difference in sighting the target through the 3D glasses more obvious. It also quickly improves identifying a dominant eye and with repeated practice the use of 3D glasses is not required. The 3D printed target 50 can be used with or without the 3D glasses.

The 3D glasses are preferably fabricated with a blue lens and a red lens that filters the image of the target 50 to provide an image that appears to have depth. Glasses 30 that are specifically manufactured for shooting are produced or certified under one or more MIL, ASTM, ANSI/ISEA Z87.1 standard and OSHA standards, such as but not limited to Z87.1-2003, Z87.1-1989 (R-1998), Z87.1-2010 and MILPR F-32432(GL). These standards establish lens thickness materials, lens mounting qualifications, frame material and testing standards. Shooting glasses that satisfy one or more of these requirements are further produced or modified with filtering material, colors, film or other treatments to allow the glasses 30 to work with the 3D target 50. Different glasses can be fabricated for indoor or outdoor use as might be found in sunglasses.

It is also contemplated that a supplemental set of glasses, lenses or film 31 may be placed in front or behind standard shooting glasses 30 to allow for a shooter 19 to use firearm glasses 30 to be used with the 3D target 50. While the color description of blue and red is used in this description it should be understood by one skilled-in-the-art of 3D glasses that other colors or filtering techniques can be used to view and image or target 50 as a 3D image.

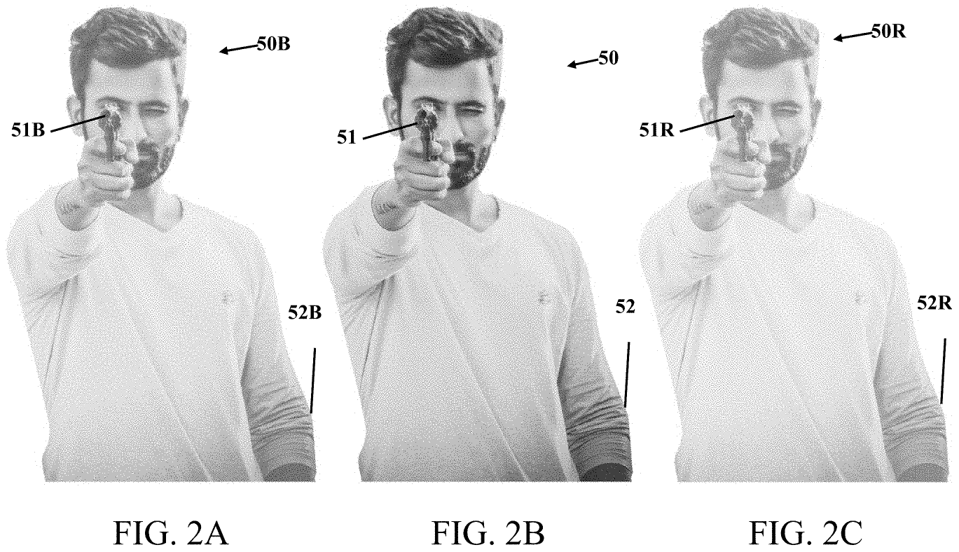

FIG. 2A-2C show the filtered and unfiltered target image. The target image 50 in the middle represents the blended stereo image. The target 50 image is created with a camera that captured (or digitally created) image is generated to provide a depth view when viewed through 3D glasses. The target 50 image is taken from the perspective of two separate images that are each filtered with lenses that are separated at a distance that is about equivalent to the distance between the two eyes of a person. The two images, target blue image 50B and target red image 50R are separately stored and are combined to produce the target 50 that can be produced with various printing techniques including, but not limited to flexographic printing, offset printing, gravure printing and screen printing transferring the image onto a substrate such as paper, plastic and metal or the like, and fusing the ink onto the substrate using heat, pressure, and/or a solvent.

The image is staged to provide a closest apparent point 51 with a blue closest apparent point 51B and a red closest apparent point 51R along with a farthest apparent point 52, a 52B blue farthest apparent point 52B and a red farthest apparent point 52R. This provides a realistic 3D appearance. In the image a person is shown holding a gun pointed essentially forward. Given the nature of the image and the printing process the barrel of the firearm appear to track a shooter as they move off-axis of the target 50.

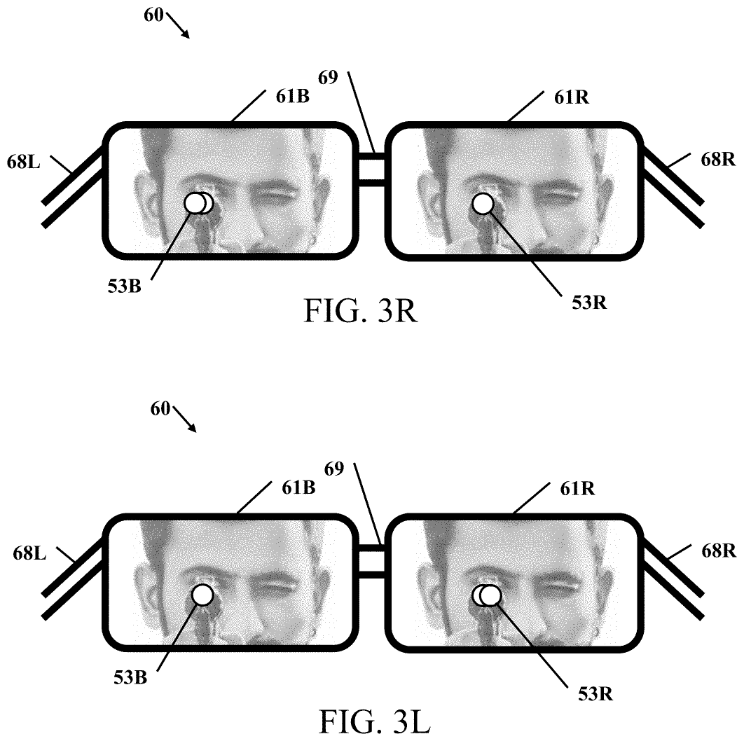

When the filtered shooting glasses 60 are worn and a user closes an opposite eye the apparent direction of the attacker gun barrel moves. FIGS. 3L and 3R show the apparent image of the target through each lens as a blue filtered lens 61B and a red filtered lens 61R. The lenses can be mounted onto a frame with a nose bridge 69, left ear frame 68L and a right ear frame 68R. In FIG. 3R the right lens shows the view of the attacker's gun barrel 53R of the gun pointing directly at the shooter, while the left lens for the attacker's gun barrel 53L off axis. In FIG. 3L the right lens shows the attacker's gun barrel 53R off access of the shooter, while the left lens for the attacker's gun barrel 53L pointing directly at the shooter.

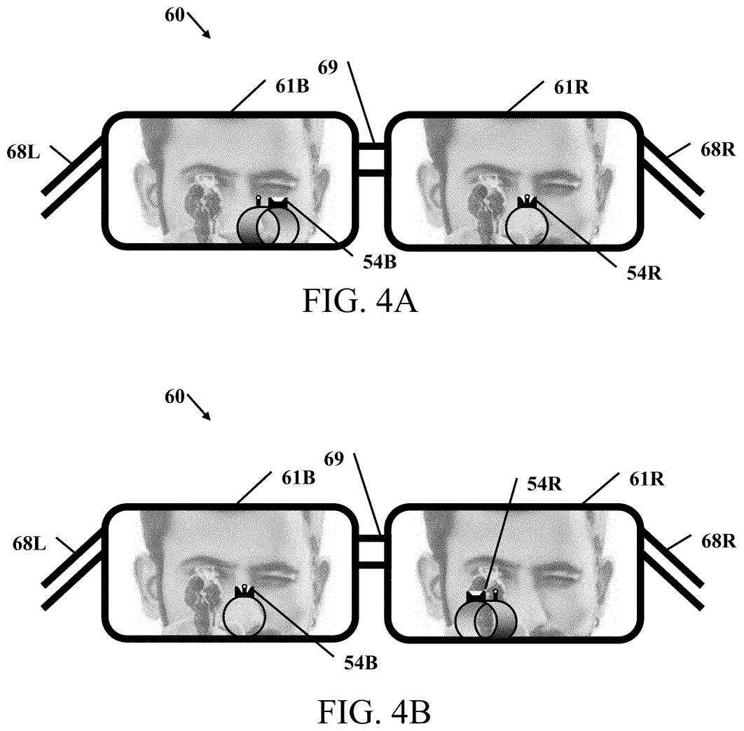

In FIGS. 4A and 4B the rear portion of the barrel of the shooter's firearm has been removed to provide some perspective view of the direction of travel of a projectile through the barrel of the shooter's firearm. It should be noted that in the figures a handgun is shown, it should be apparent that the 3D target and glasses can equally be used to train a shooter who is using a long gun, shotgun or other firearm. The lenses are shown mounted into glasses where the left frame 61B has the blue filtered lens, the right frame 61R has a red filtered lens with a nose bridge 69, left ear frame 68L and a right ear frame 68R. It is also contemplated that the filtering material can be incorporated into a clip-on or flip-down style frame to allow a user to attach the filtered lenses to their own shooting glasses or prescription based eye wear of the shooter.

FIG. 4A show the image from the target for a person with a right dominant eye through the filtered shooting glasses 60. In this figure the right dominant eye shows the barrel of the gun pointing straight through the sites 54R at the 3D target. If the user closes their dominant right eye the image in the left lens frame 61B shows that the barrel sites 54B and target has moved or shifted.

FIG. 4B show the image from the target for a person with a left dominant eye through the filtered shooting glasses 60. In this figure the left dominant eye shows the barrel of the gun pointing straight through the sites 54B at the 3D target. If the user closes their dominant left eye the image in the right lens frame 61R shows that the barrel sites 54R and target has moved or shifted. Once a shooter recognizes their dominant eye and the effect that is produced the training of a shooter to improve accuracy is quickly and repeatedly improved.

The non-dominant eye is not blocked in any embodiment and the shooter can maintain peripheral vision that allows the shooter to view additional threats and changes in the surrounding environment.

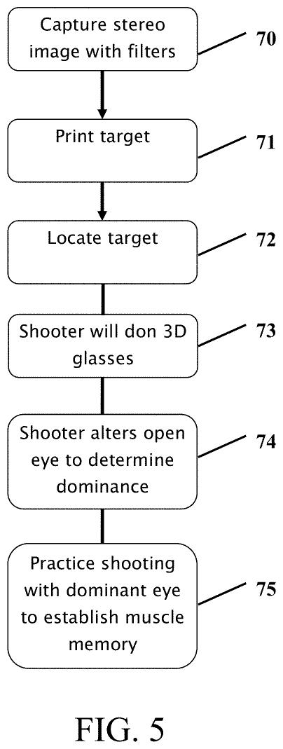

FIG. 5 shows a flow chart of acquiring a target image and training a shooter. While nearly any subject can be captured to create a 3D image, for shooting instruction the image is created to provide a friend or foe and the subject is posed to provide a stance that provides a suitable 3D image where there is a front point that extends to the shooter and some depth or background. Once the subject is properly posed the stereo image is captured 70 with filters over each lens of the camera.

The captured image can then be scaled and produced to provide the target. The target is printed 71 or produced with various printing techniques including, but not limited to flexographic printing, offset printing, gravure printing and screen printing transferring the image onto a substrate such as paper, plastic and metal or the like, and fusing the ink onto the substrate using heat, pressure, and/or a solvent.

The target is then located 72 and posed based upon the training requirements for distance, motion or the like. The shooter will don 3D glasses. The shooter can self-determine their dominant eye 74 themselves or with instructions. Repeated use and practice 75 of using the 3D glasses will enforce a shooter using a dominant eye to fire upon a target and establish muscle memory that becomes a habit to locate a target with the dominant eye while maintaining peripheral vision with the non-dominant eye to view changes in the surrounding area. The shooter will establish a habit of shooting where the 3D glasses are not required to make accurate and consistent shots at a target.

Thus, specific embodiments of a 3D target shooting training glasses and target have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A method of using a 3D target to identify a dominant shooting eye comprising:
capturing a stereo or 3D target image;
printing said target image on a substrate;
locating said printed target image in range that is configured for a shooter;
said shooter will don glasses that are configured to view said 3D target image;
using said glasses to view said 3D target images to determine a dominant eye, and practice shooting at said 3D target image to enforce use of said dominate eye when shooting at a target.

2. The method of using a 3D target to identify a dominant shooting eye according to claim 1, wherein said printing is on a flexible substrate with flexographic printing, offset printing, or gravure printing.

3. The method of using a 3D target to identify a dominant shooting eye according to claim 1, wherein said substrate is selected from a group consisting of paper, plastic and metal or the like

4. The method of using a 3D target to identify a dominant shooting eye according to claim 1, wherein said printing further includes fusing ink onto said substrate using heat, pressure, and/or a solvent.

5. The method of using a 3D target to identify a dominant shooting eye according to claim 1, wherein capturing said stereo or 3D image is capturing two separate images.

6. The method of using a 3D target to identify a dominant shooting eye according to claim 5, wherein said two separate images are captured with different filtering lenses.

7. The method of using a 3D target to identify a dominant shooting eye according to claim 1, wherein said glasses are configured to clip onto prescription glasses.

8. The method of using a 3D target to identify a dominant shooting eye according to claim 7, wherein said glasses are hinged to said prescription glasses.

9. The method of using a 3D target to identify a dominant shooting eye according to claim 1, wherein said glasses are on a frame with a nose bridge

10. The method of using a 3D target to identify a dominant shooting eye according to claim 1, wherein said stereo or 3D target image is a blue image and a red image.

11. The method of using a 3D target to identify a dominant shooting eye according to claim 10, wherein said blue image and said red image are separately stored.

12. The method of using a 3D target to identify a dominant shooting eye according to claim 11, wherein said image is printed as a blended red and blue image.

13. The method of using a 3D target to identify a dominant shooting eye according to claim 1, wherein each lens said glasses is a different color.

14. The method of using a 3D target to identify a dominant shooting eye according to claim 1, wherein said glasses are certified under at least one of MIL ASTM, ANSI/ISEA Z87.1 standard.

15. The method of using a 3D target to identify a dominant shooting eye according to claim 1, wherein said glasses are certified under at least one of OSHA Z87.1-2003, Z87.1-1989 (R-1998), Z87.1-2010 and MIL-PRF-32432(GL) standard.

16. The method of using a 3D target to identify a dominant shooting eye according to claim 1, wherein said lenses of glasses have a filtering material, colors, film or treatment.

17. The method of using a 3D target to identify a dominant shooting eye according to claim 7, wherein said lenses are configured to be placed in front of said prescription glasses.

18. The method of using a 3D target to identify a dominant shooting eye according to claim 7, wherein said lenses are configured to be placed in behind said prescription glasses.

19. The method of using a 3D target to identify a dominant shooting eye according to claim 1, wherein said capturing said stereo or 3D target image is generated to provide a depth view when viewed through said 3D glasses.

20. The method of using a 3D target to identify a dominant shooting eye according to claim 1, wherein said capturing said stereo or 3D target image is taken from a perspective of two separate images that are each filtered with different colored lenses that are separated at a distance that is configured to be a distance between two eyes of said shooter.
